(19) United States
(12) Patent Application Publication
(10) Pub. No.: US 2006/0098282 A1
(43) Pub. Date: May 11, 2006

(54) Visual media

(76) Inventors: John R McCart, Rochester, NY (US); Joseph McCart, Rochester, NY (US); Thomas McCart, Rochester, NY (US)

Correspondence Address: Knoble Yoshida & Dunleavy;Eight Penn Center, Suite 1350, 1628 John F Kennedy Boulevard, Philadelphia, PA, 19103, US

(21) Appl. No.: 10/520,379

(22) PCT Filed: Jul. 2, 2003
(86) PCT No.: PCT/US03/20748

§ 371 Date: Sep. 15, 2005

Related U.S. Application Data
(60) Provisional application No. 60/393,460, filed on Jul. 2, 2002.

(51) Int. Cl. G02B 27/24

(52) U.S. Cl. 359/472; 359/466

(57) ABSTRACT

A coloring card including a pair of stereoscopically complementary images is disclosed. The coloring card includes at least one portion of a surface of the images which is adapted to be manipulated by application of color to said surface. Also disclosed are a variety of different embodiments of such coloring cards including cards with two or more pairs of stereoscopically complementary images on one card which can be manipulated to position complementary pairs of images back-to-back relative to one another for viewing in a suitable stereoscopic viewer. Also disclosed are kits including the cards and various other items, as well as methods of making and delivering the cards electronically.

### BACKGROUND OF THE INVENTION

1. Field of the Invention

The present invention relates generally to the visual media for the provision of a variety of visual effects and to methods of producing such visual effects employing the visual media of the invention.

2. Brief Description of the Prior Art

The present invention provides a variety of visual media for the provision of a variety of different visual effects. Several patents and publications are listed below to exemplify the current art relating to some of these visual effects and to the visual media employed to provide such visual effects.

U.S. Pat. No. 5,517,355 (Sullivan et al.) relates to the provision of stereographic images using stereoscopically complementary images positioned back to back relative to one another. U.S. Pat. No. 5,384,655 (Sullivan et al.) relates to a viewing apparatus that may be used to provide a three-dimensional image from such stereoscopically complementary images positioned back to back relative to one another.

U.S. Pat. No. 5,626,551 (Kearns et al.) relates to a greeting card kit and method for using it. This patent is an example of one type of kit available for making one's own greeting cards. U.S. Pat. No. 5,807,226 (Bradley) provides foldable greeting cards. This patent provides a good description of many details on the making of greeting cards U.S. Pat. No. 4,826,211 (Sinnott et al.) describes a specific type of greeting card with two leaves and a detachable third leaf inserted into the center. The detachable third leaf could be, for example, a card intended for a return response. U.S. Pat. No. 5,359,793 (Copperstone) describes a greeting card with a bookmark. U.S. Pat. No. 4,439,941 (Halperin) discloses a card with a removable and reusable insert. For example, a photo, or card can be inserted into a pouch or pocket provided in this greeting card. U.S. Pat. No. 4,613,157 (Drabisch) discloses a reuseable greeting card. U.S. Pat. No. 4,200,222 (Feuer) discloses a greeting card with a removable decal. U.S. Pat. No. 4,952,091 (Sirko) discloses the use of a tear off addition to a double greeting card.

U.S. Pat. No. 5,076,490 (Dulin) discloses a combination index card and post card. Specifically, the postcard is provided with a punch out index card, which may be separated from the postcard by virtue of perforations provided in the postcard. U.S. Pat. No. 4,892,246 (Norman) dislcoses a postcard with a return postcard within a card with perforations so that the return postcard can be removed and sent back.

U.S. Pat. No. 6,092,841 (Best et al.) relates to a promotional one-piece mailer assembly having an integral coupon card. The Best et al. patent discloses the use of scorelines to detach the coupon. U.S. Pat. No. U.S. Pat. No. 5,992,731 (Tani) uses an adhesive layer to hold a coupon card on a mailer until the user peels off the coupon card. Each of these patents disclose the use of a pre-made card sheet, which is printed on, detached and folded together to form the mailer assembly. U.S. Pat. No. 5,826,914 (Hudetz) discloses a periodical insert having a composite structure for use with, for example, a magazine or other publication that includes a postal reply card.

U.S. Pat. No. 5,428,423 (Clark) relates to photographic printed cards and apparatus and methods of making them. This patent shows a method of making cards with a computer and printer system.

U.S. Pat. No. 6,120,295 (Pracas) discloses a visual puzzle toy, which creates a three-dimensional visual effect using image distortion by providing a card on a roller.

U.S. Pat. No. 5,778,164 (Watkins et al.) discloses a system for custom imprinting a variety of articles with images obtained from a variety of different sources. This patent selects and merges elements in a computer and then uses the merged image to imprint a variety of articles. U.S. Pat. No. 6,178,392 (Mack et al.) relates to a method for combining computer models of two surfaces in three-dimensional space.

U.S. Pat. No. 5,421,583 (Gluck) relates to print media with enhanced realism, which is created using a variety of different features.

U.S. Pat. No. 6,238,217 (Mirando et al.) relates to a video coloring book. The video-coloring book includes a processor, a display device and a selecting device. U.S. Pat. No. 6,050,604 (Ossiatzky) relates to a coloring book with pop-up figures.

U.S. Pat. No. 5,269,691 (Waldman) relates to sticker activity and a folding card like coloring book that has double-sided images which can be folded to produce pages. Added to this is the use of stickers to provide additional visual effects. U.S. Pat. No. 4,416,632 (Berman) relates to a paint-by-numbers kit.

U.S. Pat. No. 5,018,974 (Carnahan et al.) relates to a coloring book or the like with ink-reactive, fragrance-releasing areas that release an appropriate fragrance upon being colored or painted by the viewer.

### SUMMARY OF THE INVENTION

In a first aspect, the present invention relates to the provision of stereoscopically complementary pairs of images in static and/or digital forms, which can be manipulated by users through application and choice of color selections to create unique stereographic images when combined. The image may also be manipulated by other image manipulation mean such as, for example, stereomorphing, in addition to the application and choice of color by the user.

In a second aspect, the present invention relates to the provision of visual media, which employs the selection and application of colors to provide a variety of visual effects. Such visual media may include coloring books, coloring cards and images, digital stereoimage creation programs, digital stereoimage presentations (ex. Internet, programmed and/or real-time stereoimage video and static images). Such visual media can optionally be viewed through the use of presentation means including numerous stereoviewer versions, back-to-back image viewers, digital stereo displays, digital computer screens, video screens, movie screen stereographic presentations, polarized viewing means, and wavelength separation based viewing means (ex. Chromadepth, RGB and anaglyph).

### BRIEF DESCRIPTION OF THE DRAWINGS

FIG. 1 is a view of a three-dimensional coloring card in accordance with the present invention.

FIG. 2A is a view of a first side of a three-dimensional coloring postcard in accordance with the present invention.

FIG. 2B is a view of the second side of the three-dimensional coloring postcard depicted in FIG. 2A.

FIG. 3 is a view of a three-dimensional coloring greeting card in accordance with the present invention.

FIGS. 4A and 4B are views of the front and back sides, respectively of a magazine insert in accordance with the present invention.

FIG. 5 is a view of a digitally created three-dimensional coloring card in accordance with the present invention.

FIG. 6 shows a kit according to the present invention packaged in a box.

FIG. 7 shows a coloring book in accordance with the present invention with one page separated and one coloring card separated and folded.

FIG. 8 shows a second embodiment of a kit in accordance with the present invention packaged in a clamshell package.

FIG. 9 shows a shipping/display box for shipping and/or displaying the kits in accordance with the present invention.

FIG. 10 shows a top view of another embodiment of a kit in accordance with the present invention that includes a tabletop viewing apparatus and is packaged in a clear clam shell package.

FIG. 11 is an exploded view of the kit of FIG. 10.

FIG. 12A is a front view of a coloring card in accordance with the present invention with the complementary images printed on the front and back of the card.

FIG. 12B is a rear view of the coloring card shown in FIG. 12A.

FIG. 13 shows the front and back of a two image coloring card in accordance with the present invention.

FIG. 14A shows an alternative embodiment of a two image coloring card in accordance with the invention.

FIG. 14B shows the card of FIG. 14A folded to position a first set of stereoscopically complementary images positioned back-to-back relative to one another.

FIG. 14C shows the card of FIG. 14A folded to position a second set of 'stereoscopically complementary images positioned back-to-back relative to one another.

FIG. 15A is a cross-sectional view of special computer paper for use in making the cards of the present invention.

FIG. 15B is a cross-sectional view of the paper of FIG. 15A folded to make a card in accordance with the present invention.

FIG. 16 is a top view of the paper of FIG. 15A.

### DETAILED DESCRIPTION OF THE PREFERRED EMBODIMENTS

In a first aspect, the present invention relates to the provision of stereoscopically complementary pairs of images in static and/or digital forms, which can be manipulated by users through application and choice of color selections to create unique stereographic images when combined. The image may also be manipulated by other image manipulation mean such as, for example, stereomorphing, in addition to the application and choice of color by the user.

In one basic form, the invention provides a stereoscopically complementary pair of images having one or more areas available to a user to provide a color selection to those areas. In this manner, the user can customize the each individual image by selecting and/or applying a color to one or more areas of the image to thereby provide a unique pair of stereoscopically complementary images customized by that user.

The invention may be implemented in a variety of forms. For example the invention can encompass the color selection feature in a coloring book format wherein one or more area available for color selection are delineated by line drawings enclosing the areas and the areas may be filled in by a pen, pencil, crayon, or some other coloring device which imparts a coloring fluid to the area.

As a simple stereographic coloring card format, a stereopair of images can each be independently colored and when viewed in stereographic combination create unique, customized three-dimensional visual experiences. This application of the invention can be presented in any of the following formats: 1) a back-to-back stereographic format as in the Sullivan et al. patent mentioned above; 2) in a side-by-side format for side-by-side stereoimage viewing (ex. Stereopticon); or 3) in a side-by-side or above-and-below format that can be folded to provide a back-to-back stereoscopically complementary pair of images for viewing.

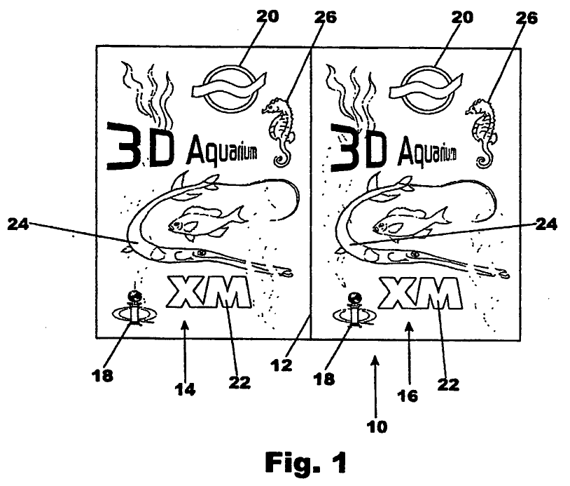

Referring to FIG. 1, there is shown a coloring card 10 in accordance with the present invention formatted in a side-by-side presentation that can be folded along fold line 12. The coloring card 10 includes a stereoscopically complementary pair of images 14, 16 which are arranged so that by folding the coloring card 10 along fold line 12, the stereoscopically complementary images may be positioned back-to-back relative to one another such that the images are registered for stereoscopic viewing using a suitable viewer for back-to-back images. Included in the card shown in FIG. 1 are examples of three-dimensional logos 18, two-dimensional logos 20, three-dimensional text 22, and three-dimensional graphic elements and objects 24. The two-dimensional logo 20 may optionally be highlighted by color manipulation and/or retinal rivalry as described below.

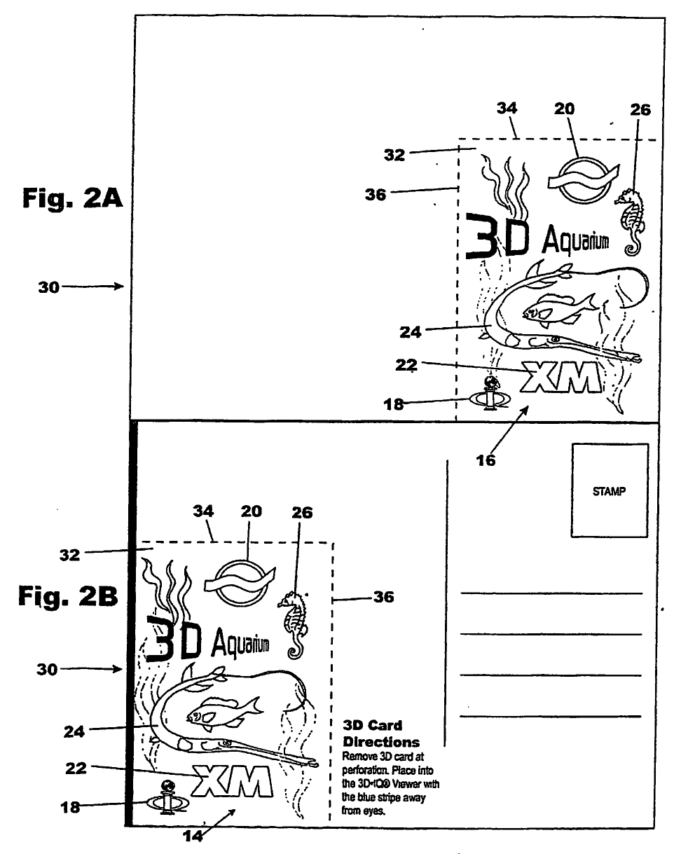

Referring to FIG. 2, there is shown an embodiment of a three-dimensional coloring postcard 30. The coloring postcard 30 exemplifies the incorporation of a stereographic coloring card in a postcard form. Similar to the coloring card 10 of FIG. 1, the coloring card portion 32 of the postcard 30 may include one or more of three-dimensional logos 18, two-dimensional logos 20, three-dimensional text 22, three-dimensional graphic elements and objects 24, as well as standard two-dimensional objects 26. The postcard 30 includes a stereoscopically complementary pair of images 14, 16, which are arranged back-to-back on the postcard 30 as shown in FIGS. 2A-2B. When the stereoscopically complementary pair of images 14, 16 are removed from the postcard 30 by tearing along score lines 34, 36, a card having back-to-back stereoscopically complementary images 14,16 is obtained. This card can be used in any conventional three-dimensional viewing apparatus suitable for viewing back-to-back stereoscopically complementary image pairs. The stereoscopically complementary images 14, 16 may be the only images on the postcard 30 or they may form part of larger images.

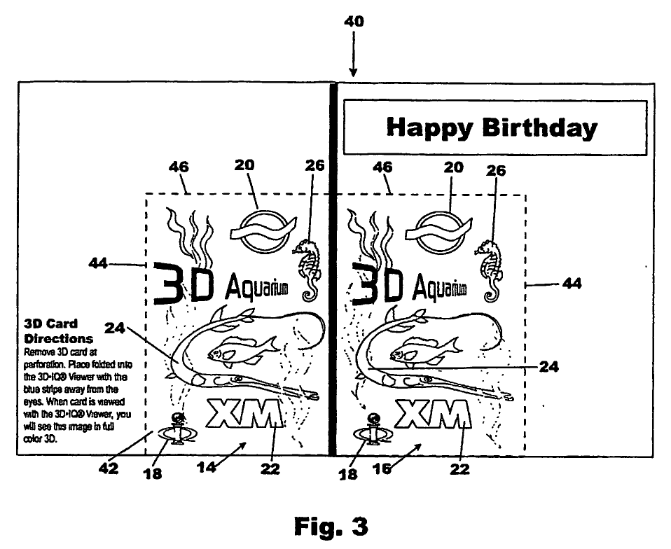

Referring to FIG. 3, there is shown an embodiment of a three-dimensional coloring greeting card 40 that exemplifies the incorporation of a stereographic coloring card such as is depicted in FIG. 1 in a greeting card form. The coloring greeting card 40 includes a pair of stereoscopically complementary images 14, 16 arranged on the greeting card 40 such that when the coloring card portion 42 is removed by tearing along score lines 44, 46, a coloring card 42 having stereoscopically complementary images 14, 16 positioned back-to-back relative to one another is obtained. Again, images 14, 16 may form part of a larger image or scene on the greeting card 40. Similar to the card of FIG. 1, the coloring card portion 42 of the greeting card may include one or more of three-dimensional logos 18, two-dimensional logos 20, three-dimensional text 22, three-dimensional graphic elements and objects 24, as well as standard two-dimensional objects 26.

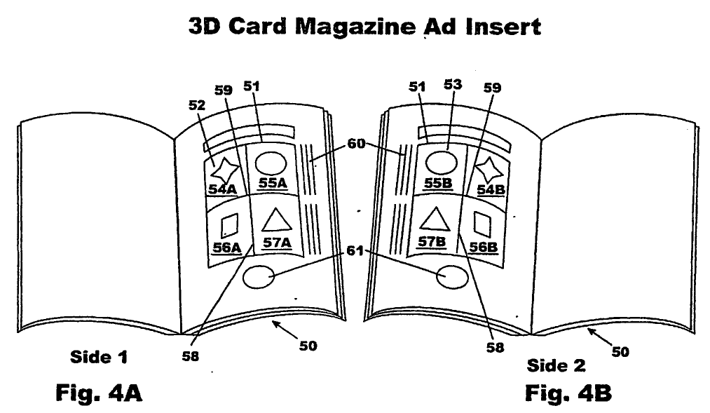

Referring to FIGS. 4A and 4B, there is shown a magazine insert 51 for a magazine 50. The insert 51 includes a front side 52 bearing, in this embodiment, four different images 54A, 55A, 56A and 57A and a back side 53 bearing the stereoscopically complementary images 54B, 55B, 56B and 57B for the images on the front side 52 of insert 51. The insert 51 may be cut out of the magazine 50 and split into four separate coloring cards along score lines 58, 59, each of which will have a stereoscopically complementary pair of images 54A, 54B; 55A, 55B; 56A, 56B; and 57A, 57B arranged back-to-back relative to one another. Magazine 50 may include other textual material 60 or pictures 61 in addition to the insert 51 on the same pages in order to provide an attractive display or advertisement, for example. In this manner, such an insert 51 can be used as a promotion or as art of an advertising campaign.

The 3D magazine coloring insert exemplifies the incorporation of a stereographic coloring card in a magazine insert or other imbedded printed media format. Other examples of imbedded print media forms include the incorporation of stereographic coloring cards into consumer packaging (e.g. cereal boxes), comics, books, newspapers, games and game cards, coupons, wrappers, and virtually any other form or printed media or packaging. Similar to FIGS. 1-3, 3D logos, flat logos, 3D text, 3D graphic elements and objects, as well as two-dimensional text and/or logos may be incorporated into the coloring card of the insert.

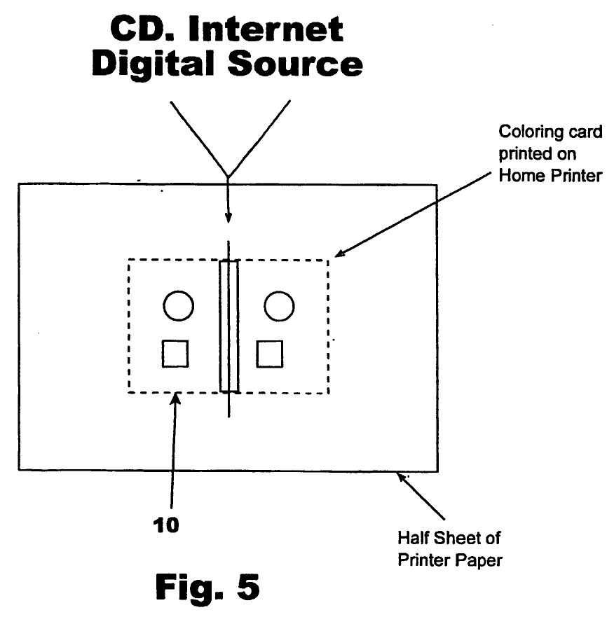

Referring to FIG. 5, there is shown a 3D stereographic coloring card 10 that can be created digitally from a CD, software program, web site download, email or other digital, electronic or world wide web conveyance. The resulting output can be in the form of a stereographic coloring card, 3D coloring postcard, 3D coloring greeting card, 3D coloring coupons, 3D coloring game card, 3D coloring paint by numbers, 3D coloring magazine insert or any other printed 3D coloring presentation form. Again, these coloring cards 10 can include examples of 3D logos, flat logos, 3D text, 3D graphic elements and objects, as well as two-dimensional graphics and text. The 3D coloring card 10 can be printed on a templated, pre-scorered and/or adhered label/paper to facilitate users in printing such cards. Once printed, the 3D coloring card can be colored, separated from the label stock backing, folded and adhered to create a unique 3D stereocard.

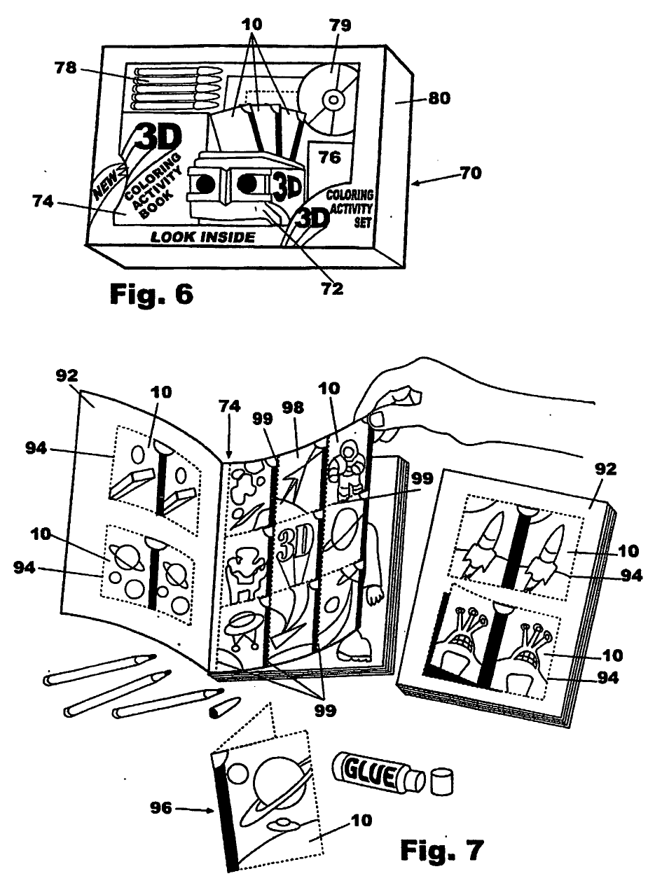

Referring to FIG. 6, there is shown a kit 70 which may include one or more of a viewing apparatus 72, one or more coloring cards 10, a coloring book 74, a storybook 76, crayons or markers 78, and a data storage device such as a CDRom 79 with digitized coloring cards, information, pictures, stories, links to websites, instructions and/or ordering information. The kit 70 may be packaged in suitable package such as a box 80 or a clam shell package 90 as shown in FIG. 8. A plurality of kits 70 packaged in boxes 80 or clam shell packages 90 can be shipped in a combined shipping/display box 100 as shown, for example, in FIG. 9. Display information can be provided on the shipping/display box 102 at, for example, box back 104.

Referring to FIG. 7, there is shown a coloring book 74 which may form part of the kit 70 of FIGS. 6 and 8. Coloring book 74 may include a plurality of coloring cards 10 arranged in a variety of different formats. For example, coloring cards 10 may be arranged two to a page in side-by-side format as shown on pages 92. In such a case, each coloring card 10 may be removed by virtue of perforations 94 surrounding the coloring card 10 and the coloring card 10 can be folded to place the images back-to-back relative to one another as shown at 96 in FIG. 7 for viewing in a viewing apparatus 72.

Another page design 98 for the coloring book 74 is shown in FIG. 7, which includes nine separate coloring cards 10 to a page with the images already positioned back-to-back relative to one another. In FIG. 7 only one of the two images forming an image pair can be seen since the other image of the pair is located on the back side of the page 98. Perforations 99 may be provided to separate the coloring cards 10 from the page 98 and from one another.

In this embodiment, it is also possible to form a single, larger image on page 98 from a combination of two or more coloring cards 10 positioned adjacent to one another. A variation on this embodiment is to make the coloring cards 10 form part of a larger image which also includes image elements which are not on coloring cards 10 when the cards are separated from the page 98.

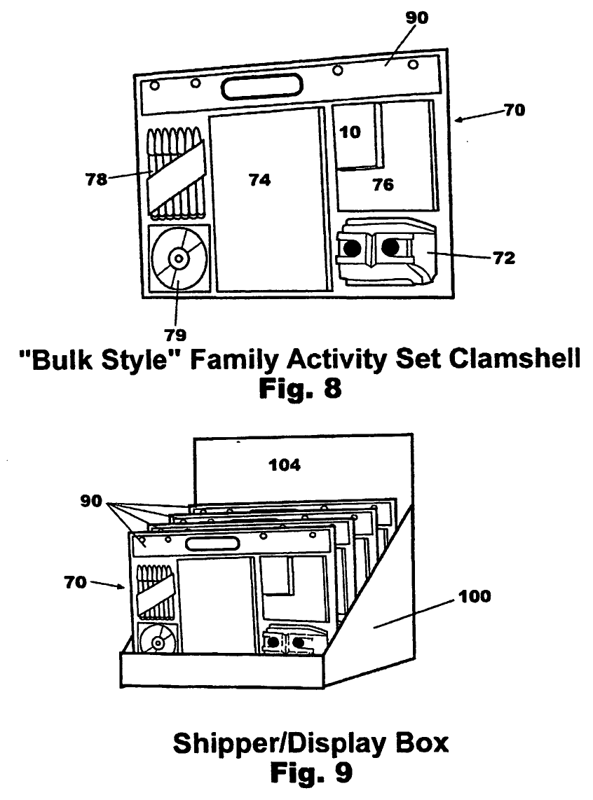

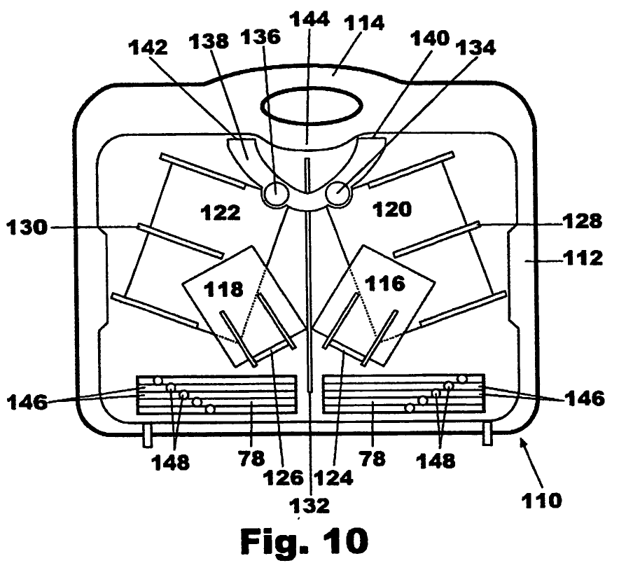

Referring now to FIG. 10, there is shown a different embodiment of a kit 110 packaged in a clam shell package 112 including a handle 114. Kit 110 may include crayons or markers 78 and a coloring book or coloring cards, not shown. Kit 110 is specially designed to include a tabletop viewing apparatus, which is shown in a folded position for storage in FIG. 10. The tabletop viewing apparatus includes mirrors 116, 118, 120 and 122 that fold upwards on hinges 124, 126, 128 and 130 to a substantially vertical position for viewing a stereoscopic pair of complementary images positioned back-to-back relative to one another in slot 132. Kit 110 also includes a pair of lenses 134, 136 positioned on a lens mount 138 shown in the folded position for storage in FIG. 10. Lens mount 138 folds up to a substantially vertical position by virtue of hinges 140, 142 such that the user can look at the three dimensional image through lenses 134, 136 in order to enhance the image. Kit 110 may also include an indentation 144 for placement of the chin of the user in order to look through the lenses 134, 136. Crayons or markers 78 can be positioned horizontally in grooves 146 for storage and crayons or markers 78 can be positioned vertically in use in round holders 148.

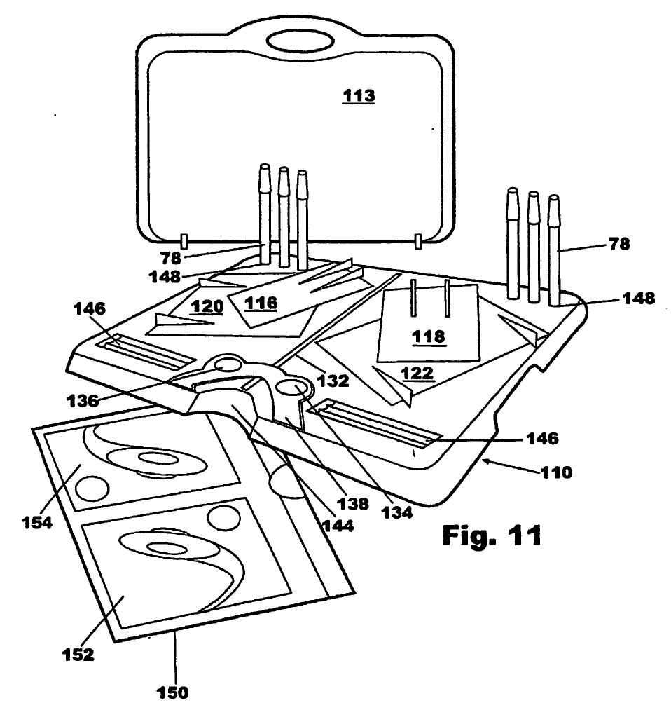

Referring now to FIG. 11, there is shown an exploded view of the Kit 110 of FIG. 10 with the clam shell top 113 removed from clam shell package 112. Also shown in FIG. 11 is a full page coloring card 150 which is divided into a complementary images 152, 154 such that the full page coloring card 150 can be folded to place images 152, 154 back-to-back relative to one another and then folded coloring card 150 can be inserted into slot 132 for viewing in the tabletop viewing apparatus.

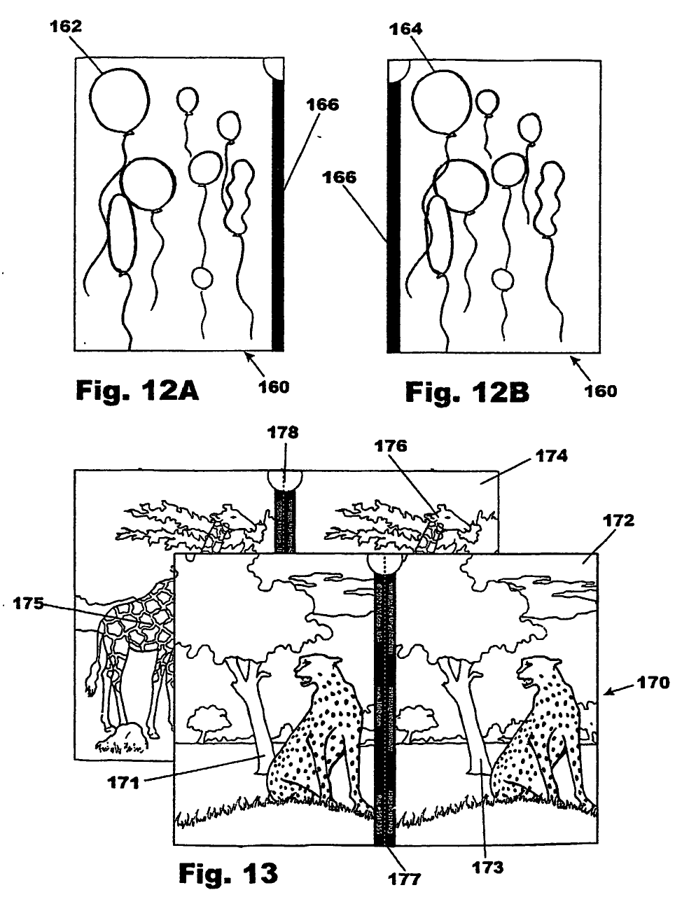

Referring to FIGS. 12A and 12B, there is shown a coloring card 160 in accordance with the present invention. Coloring card 160 has a first, right-eye stereographic image 162 printed on the front of the card 160, as shown in FIG. 12A, and a second, left-eye stereographic image 164 on the back of the card 160, as shown in FIG. 12B. The card 160 also includes an indicator edge 166 to indicate the proper orientation of the card 160 when inserted into a stereoscopic viewer.

Referring to FIG. 13, there are shown front 172 and rear 174 views of a two-image coloring card 170. The two-image coloring card 170 includes a first pair of stereoscopically complementary images 171, 173 on the front 172 of the card 170, and a second pair of stereoscopically complementary images 175, 176 on the back 174 of the card 170. Both the front 172 and back 174 of the card 170 include an indicator edge 177, 178 to indicate the proper orientation of the card 170 when folded and inserted into a stereoscopic viewer for viewing one of the images in 3D. The card 170 may be folded along the indicator edge 177, 178 for positioning each stereoscopically complementary image pair back-to-back relative to one another for 3D viewing in a suitable stereoscopic viewer.

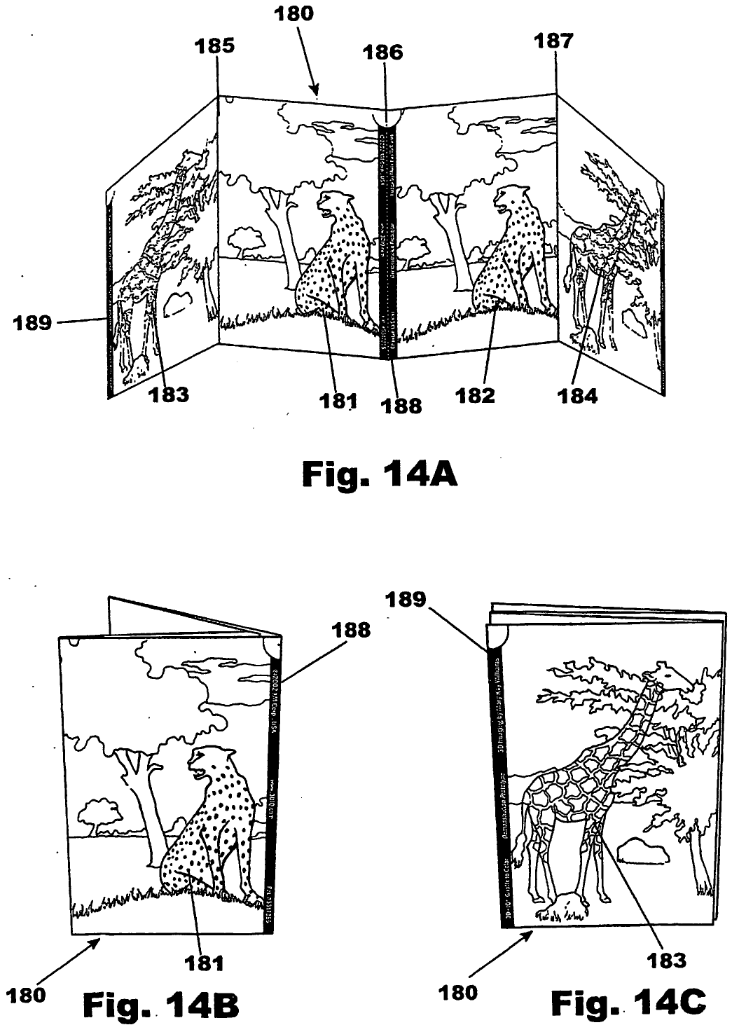

Referring to FIG. 14A, there is shown a multi-fold version of a two-image coloring card 180 in accordance with the present invention. In this embodiment, the card 180 includes a first pair of stereoscopically complementary images 181, 182 on the same side of the card as a second pair of stereoscopically complementary images 183, 184. Card 180 includes fold lines 185, 186 and 187 along which the card can be folded to position the first and second pairs of stereoscopically complementary images 181, 182, 183 and 184 back-to-back relative to one another. Card 180 also includes first and second indicator edges 188, 189 for indicating the proper orientation of the card 180 in a stereoscopic viewer for 3D viewing of the first and second image pairs, respectively. FIG. 14B shows card 180 folded for viewing of the first pair of stereoscopically complementary images 181, 182. FIG. 14C shows card 180 folded for viewing of the second pair of stereoscopically complementary images 183, 184. Card 180 may optionally be a three- or four-image card by adding one or two additional pairs of stereoscopically complementary images onto the back of the card 180 in a manner similar to that shown on the front of the card in FIG. 14A.

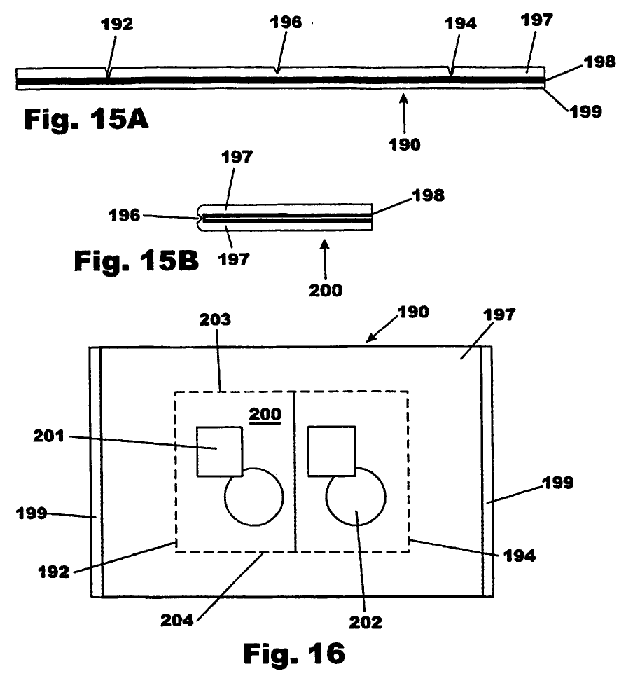

Referring to FIG. 15A, there is shown a cross-sectional view of a special computer paper 190 adapted for making coloring cards in accordance with the present invention. Computer paper 190 includes perforations 192, 194 and a fold line 196 for folding the paper 190. Computer paper 190 is made up of a paper printing surface 197, an adhesive layer 198 and a peel away backing layer 199.

To make a card 200, as shown in FIG. 15B from the computer paper 190 of FIG. 15A, stereoscopically complementary images 201, 202 are printed onto the printing surface 197, as shown in FIG. 16. Then, the card 200 is removed from the computer paper 190 by tearing along perforations 192, 194, 203 and 204. Then, the peel away backing paper 199 is removed and the card 200 is folded along fold line 196 to position the images 201, 202 back-to-back relative to one another and the adhesive layer 198 is attached to itself as shown in FIG. 1 5B.

The invention can be embodied into stereographic video sources that can be presented in a stereo color manipulated or enriched form. This use of color manipulation to accentuate stereographic presentation of imagery allows further enhancement of the images and highlighting of specific elements, personalities, icons or backgrounds. Alternatively, the color selection may be implemented electronically whereby the user can make color selections using a computer provided with a coloring program or an image creation program that has the ability to provide colors, color patterns or color combinations to the areas available for color selection. Such electronic implementation also allows the user the possibility of manipulating the image in other ways using other types of image manipulation means such as, for example, stereomorphing to create unique visual effects.

Through the selection of colors, color patterns and the manipulation of color to accentuate stereographic images retinal rivalry can be created. Retinal rivalry has been described in the literature. The respective images are not required to be a stereoscopically complementary pair to create a retinal rivalry effect when viewed in a combined form. Thus, the present invention encompasses the application of retinal rivalry to pairs of images whether they are stereoscopically complementary or not. For example, retinal rivalry can be employed to produce a shimmering effect where each different color fluctuates back and forth from eye to eye as perceived by the brain, or a third different color can be created and perceived by the brain through the merging of the two different colors as a result of the retinal rivalry effect. The shimmering or merging color effects can create unique, creative and/or pleasing images for the viewer. Retinal rivalry can also be used to determine whether a particular user has a strong, dominant eye since that user will generally only see one of the two colors and not a blending or shimmering effective.

In fact, a simple test for eye dominance is to prepare a card in accordance with the present invention having single color right and left eye images wherein the left eye image is a different color than the right eye image. The card is put into a viewer and the user is asked the following questions:
1) Of the two colors in the selected area, which appears first?
2) Which color is the most prominent of the two colors?
3) Are the two colors viewed alternately to produce a shimmering effect?

The invention provides the following advantages:
1) The ability to read and render in 3D, text, which can include colored text.
2) The ability to have the right and left eyes view different colors creating a retinal rivalry effect. The high impact and excitement of the combined coloring effect enhancing the visual experience and prospectively recognition of the images.
3) The highlighting of specific elements such as logos, names, slogans, individuals or instructions can use to create a high impact, lasting impression of those elements. This can be very valuable for emphasis or the imprinting of educational or promotional messages.
4) These high impact effects can be provided in a cost effective, customizable manner using existing print and image creation methods.
5) Unique, low cost color enhanced imaging capability is accessible to virtually every user and can be independently created and reproduced by users at home without the requirement of sophisticated inputs.
6) Twice as much coloring time is required to create a 3D coloring card image capturing the interest of the users for longer thereby enhancing value.
7) The greater degree of creativity, effort and thought required to create 3D stereographic coloring images increases the interest and entertainment value of coloring beyond the traditional young child segment that is currently engaged in coloring.
8) The invention creates the ability to uniquely manipulate an underlying stereographic image outline to provide multiple, different colorations of the same image thereby enhancing the value of each individual uncolored image.
9) Color by number stereographic and two-dimensional images can be created to guide users to the maximum effect of retinal rivalry via color clash (shimmering effect) or color merge. Having light and dark shades of the same color or white and color can also be used to create interesting visual effects.
10) The invention enables digital delivery and distribution (i.e. world wide web, CD, streaming video etc.) in a unified format that allows for a standardized creation process, sand a standardized way to view the image.
11) The invention can be applied for use as a means for ocular testing of individual eye dominance factors.
12) The invention's use of color merging and/or retinal rivalry combined with stereographic viewing of images can potentially be incorporated as a means to treat and train eyes in order to reduce ocular disparities including some forms of stereo blindness, color recognition, color blindness and lazy eye.
13) The invention can be used as a unique means to teach elements of color theory, light wavelength interactions, and combinative color.
14) The invention enables color interactions and color patterns to be uniquely combined into depth fields used in stereographic morphing techniques. By combining the invention with digital stereomorphing, new and more interesting stereographic images can be created using coloring and the retinal rivalry effects.

It is also possible to have a computer program create outlines of coloring areas in order to create coloring cards in electronic or hard copy form, which may then be colored in. A software or digital application that can outline and automatically shift the outline of image elements to create a stereographic coloring outline can be used to make electronic and/or hard copy coloring cards in accordance with the present invention.

Color selection can be accomplished in many different ways. For example, color selection can be done by: 1) manual color determination (e.g. Crayons), 2) manual/digital color determination (e.g. light pens), 3) predetermined manual color pairings (e.g. paint by numbers), 4) predetermined or randomized color pairings done electronically (e.g. digital paint by numbers), along with 5) pre-colored printed color pairings (e.g. pre-colored cards with a choice of color themes or patterns, e.g. holiday images).

Additional products incorporating the present invention can include:
1) 3D Coloring Valentines or Holiday Coloring Cards,
2) 3D Coloring Cards as Advertising sheets,
3) 3D Coloring books,
4) 3D Coloring cards imbedded into books, magazines, newspapers or packaging,
5) 3D CD's with digital home printable Coloring Image files,
6) Specialty paper for Computer printouts composed for ease of coloring,
7) Specialty paper for digital or manual coloring with textured surface to enhance 3D coloring effects,
8) Pre-Colored Stereocards alone or with a CD-Rom with printable cards.
   a) Manual—color your own,
   b) Digital pre-selected Forms—already colored,
9) 3-D Coloring Cards for emailing and download on the world wide web,
10) Pre-selected Paint by Numbers with predetermined color combinations
   a) Manual stereo paint by numbers,
11) Stickers (Normal, Holographic, Prismatic) to incorporate into 3D coloring card effect,
12) Adhesive Mechanisms built into side by side 3D Coloring Cards,
13) Printable adhesive peel off or punch out printable label sheets,
14) Attached 3D Coloring cards imbedded in 3D Postcards, 3D Greeting Cards, 3D Magazine inserts, packaging etc.,
15) 3D Coloring Coupons,
16) 3D Coloring Game Cards (ex. Place cards in Viewer to see if you win as reflected by a unique 3D color or effect pattern),
17) Attached folded strips of 3D Coloring cards,
18) Attached sheets uncut, perforated or peel and stick 3D Coloring cards,
19) Any of these 3D products in digital, electronic, Internet, software or downloadable forms,
20) Any of these 3D products in preprinted, predetermined or manually selected forms,
21) Opthamological training images both manual and digital, both predetermined and self-colored,
22) 3D Coloring products incorporating sticker to embellish and educate about 3D depth fields,
23) 3D Learning tool to teach concepts of color theory through 3D Coloring Cards,
24) 3D Learning tool to teach concepts of depth theory through 3D Coloring Cards in combination with colors, elements and stickers,
25) 3D Coloring Images which also can be separated as pop-up figures, and
26) 3D versions of one or more of the foregoing without the coloring feature included therein.

The coloring card can have the images printed side-by-side for folding to position the images back-to-back relative to one another, or the coloring card can have the images printed on the front and back of a card so that they are arranged back-to-back relative to one another. Each area on the coloring card can be labeled with a number which corresponds to a particular color. The colors used for the same portion of both of the right and left eye images can be:
A. The same to produce the same shade when viewed in 3D as when one of the two images is viewed alone as a two-dimensional image.
B. Complimentary colors—This produces a different color that can be predicted from the CIE color charts when the image is viewed in 3D than when one of the two images is viewed alone as a two-dimensional image. If the user has a strong eye dominance issue, then only one color will show when the image is viewed in 3D.
C. Different shades of the same color—This produces either a blending to provide a color between the two different shades, when the image is viewed in 3D, or a shimmering effect whereby the two different shades are viewed alternately by the user. Again, if the user has a strong eye dominance issue, then only one of the two shades will be viewed in 3D.
D. Different, non-complimentary colors - This produces either a blending to provide a color between the two different colors, when the image is viewed in 3D, or a shimmering effect whereby the two different colors are viewed alternately by the user. Again, if the user has a strong eye dominance issue, then only one of the two colors will be viewed in 3D.

The coloring card of the present invention may also be implemented as a “Forever Coloring Card” in which case treated paper, plastic or other suitable media are employed to provide a coloring card where color can be applied, removed and another color can be applied, one or more times to permit various permutations using a single coloring card. Preferably, such a card has a wipe-away surface which permits application of color, wiping of the color from the surface, and application of color again. This version of the coloring card allows the user to experiment with different color combinations to obtain the various color effects mentioned above.

The coloring card of the present invention may also be employed for use in a coloring card contest. In this embodiment, certain select cards may have special three-dimensional effects, which distinguish those cards from other, similar coloring cards. In this manner, the winning cards are practically indistinguishable from the remaining cards when viewed as two-dimensional images by looking at the card without using a special viewer, for example. However, by using the viewer, a special three-dimensional effect can be identified which can be used to distinguish the winning cards from the remaining cards. The winning cards can be distinguished from the remaining cards in any number of ways. For example, the winning cards may have a certain element that is three-dimensional when viewed through the viewer whereas that same element appears two-dimensional on the remaining cards. Also, a certain item on the card can be highlighted by locating it in a different image plane and/or making it the only two-dimensional image on the card when the card is viewed using a viewing apparatus.

Alternatively, a prize indication could be made three-dimensional on the winning cards such that not only can a winning card be identified, but he prize can be identified as well. The prize and/or winning card identification can be done with pictures, symbols and/or words and phrases, for example.

Also, a separate master card can be made for the purpose of pairing this card with a contest card having a single image on it. The master card may, for example, contain a right-eye image and all of the contest cards a left-eye image. Winning cards can be identified by pairing the master card with a contest card and viewing the pair with a viewing apparatus to determine if a particular three-dimensional effect is present or not.

Another effect that can be employed with any of the various embodiments of the coloring card of the present invention is windowing. Windowing involves the selection of a particular plane in three-dimensional space, which will represent the reference plane upon which the remainder of the image is based. Once a particular plane is selected, elements of the image can be “windowed” by rendering the elements in a manner whereby they appear to be in a different plane than the reference plane. Thus, particular elements may appear to be in a plane that is closer than the reference plane to make a particular image element appear closer or particular elements can be made to appear in a plane that is farther away than the reference plane to make that particular image element appear farther away. The invention encompasses the modification of stereopairs to employ windowing in order to make a particular element of the image appear closer or farther away, relative to the remainder of the image and the reference plane.

The coloring cards of the present invention can also be used to help treat persons with certain types of eye problems and/or to stimulate brain activity. More specifically, persons with lazy eye tend to have weak muscles in their eyes. Using the coloring cards of the present invention along with a viewing apparatus can be employed as a manner of exercising the muscles of the eyes since they eye muscles must be used to fuse the left and right eye images, as well as to focus the three-dimensional image. In addition, the viewing of three-dimensional images using a viewing apparatus can stimulate neural pathways in both hemispheres of the brain and help coordinate the eyes and brain. At the same time, educational materials can be used as part of the images in order to educate the user of the viewing apparatus.

A variety of other embodiments of the present invention are shown on the following pages, which are self-explanatory. One or more of these embodiments can be used as part of other embodiments of the present invention and/or in combination with other embodiments of the present invention.

1. A card specially adapted for use in a stereoscope that provides a three-dimensional image from two registered stereoscopically complementary images which are positioned substantially back-to-back relative to one another, said card comprising two stereoscopically complementary images positionable back-to-back relative to one another for viewing using said stereoscope, said individual stereoscopically complementary images are not mirror images of the three-dimensional image viewable from the card when employing the stereoscope, the stereoscopically complementary images are affixed to the card such that the stereoscopically complementary images are registered relative to one another when the images are positioned back-to-back relative to one another to thereby provide a consistent three-dimensional image when viewed using the stereoscope, said images including at least one portion of a surface of said images which is adapted to be manipulated by application of color to said surface.

2. A card as claimed in claim 1, wherein said stereoscopically complementary images are attached to opposite sides of said card.

3. A card as claimed in claim 1, wherein said stereoscopically complementary images are attached to the same side of said card.

4. A card as claimed in claim 3, wherein said card further comprises at least one fold line for indicating to a user where to fold said card in order to position the stereoscopically complementary images back-to-back relative to one another in a position whereby the images are registered.

5. A card as claimed in claim 4, wherein the images are attached to said card such that the images are positioned side-by-side relative to one another.

6. A card as claimed in claim 4, wherein the images are attached to said card such that the images are positioned above and below one another, with one of said images being upside down relative to the other image when said card is in an unfolded configuration.

7. A card as claimed in claim 3, wherein said card comprises one pair of stereoscopically complementary images located on one surface of said card and a second pair of stereoscopically complementary images located on a second surface of said card.

8. A card as claimed in claim 4, wherein said card has two surfaces, at least two pairs of stereoscopically complementary images on one surface of said card, and wherein said card includes two or more fold lines for indicating to a user where to fold said card in order to position each of the pairs of stereoscopically complementary images back-to-back relative to one another in a position whereby the complementary images are registered.

9. A card as claimed in claim 1, further including textual matter on at least one surface of the card.

10. A card as claimed in claim 1, wherein said at least one portion of said card which is adapted to be manipulated through application of color is also adapted such that the applied color selection can be removed from said portion and replaced by application of another color selection.

11. A card as claimed in claim 10, wherein said card comprises a wipe-away surface which permits the application of color, and the removal of color by wiping the color from the surface of said card.

12. A book comprising a plurality of cards as claimed in claim 1.

13. A card as claimed in claim 1, wherein said card is specially adapted for use in the stereoscope to provide a three-dimensional image from two registered stereoscopically complementary images which are positioned substantially back-to-back relative to one another and is part of a stereoscopic viewing kit including a stereoscope.

14. A card as claimed in claim 4, wherein the images are attached to said card such that the images are positioned side-by-side relative to one another.

15. A card as claimed in claim 4, wherein the images are attached to said card such that the images are positioned above and below one another, with one of said images being upside down relative to the other image when said card is in an unfolded configuration.

16. A card as claimed in claim 4, wherein said card comprises one pair of stereoscopically complementary images located on one surface of said card and a second pair of stereoscopically complementary images located on a second surface of said card.

17. A card as claimed in claim 5, wherein said card comprises one pair of stereoscopically complementary images located on one surface of said card and a second pair of stereoscopically complementary images located on a second surface of said card.

18. A card as claimed in claim 6, wherein said card comprises one pair of stereoscopically complementary images located on one surface of said card and a second pair of stereoscopically complementary images located on a second surface of said card.
